(19) United States
(12) Patent Application Publication
(10) Pub. No.: US 2013/0261275 A1
(43) Pub. Date: Oct. 3, 2013

(54) NON-HOMOPOLYMERS EXHIBITING GAS HYDRATE INHIBITION, SALT TOLERANCE AND HIGH CLOUD POINT

(71) Applicants: Osama M. Musa, Kinnelon, NJ (US); Jui-Chang Chuang, Wayne, NJ (US); Yi Zhang, Nutley, NJ (US); Jun Zheng, Morris Plains, NJ (US)

(72) Inventors: Osama M. Musa, Kinnelon, NJ (US); Jui-Chang Chuang, Wayne, NJ (US); Yi Zhang, Nutley, NJ (US); Jun Zheng, Morris Plains, NJ (US)

(73) Assignee: ISP Investments Inc., Wilmington, DE (US)

(21) Appl. No.: 13/879,746

(22) PCT Filed: Oct. 19, 2011
(86) PCT No.: PCT/US11/56834

§ 371 Date: Jun. 6, 2013

Related U.S. Application Data
(60) Provisional application No. 61/405,289, filed on Oct. 21, 2010.

(51) Int. Cl. C08F 226/06

(52) U.S. Cl. CPC C08F 226/06
USPC 526/264

(57) ABSTRACT

Polymers are provided that offer gas hydrate inhibition, salt tolerance, and high cloud point. The polymers are polymerized from at least (A) 50 mole percent or more of a monomer selected from the group consisting of: N-vinyl-2-caprolactam, one of its analogues, and combinations thereof, (B) an alkenyl sulfonic acid monomer, salt thereof, or combinations thereof, and (C) an TV-vinyl amide, a (meth)acrylamide or one of its analogues, or combinations thereof. In one embodiment, the (A) monomer is N-vinyl-2-caprolactam, the (B) monomer is 2-acrylamido-2-methylpropane sulfonic acid or salt thereof, and the (C) monomer is N-vinyl-2-pyrrolidone, acrylamide, methacrylamide, or combinations thereof.

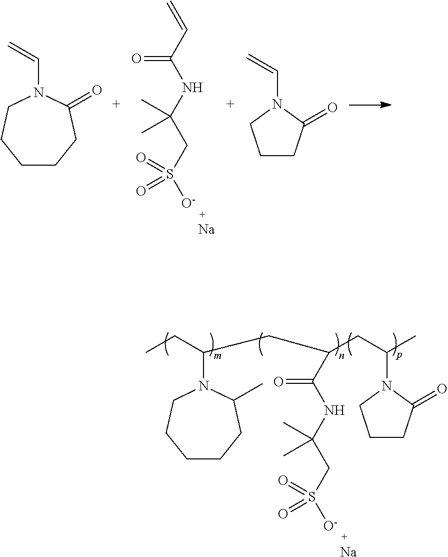

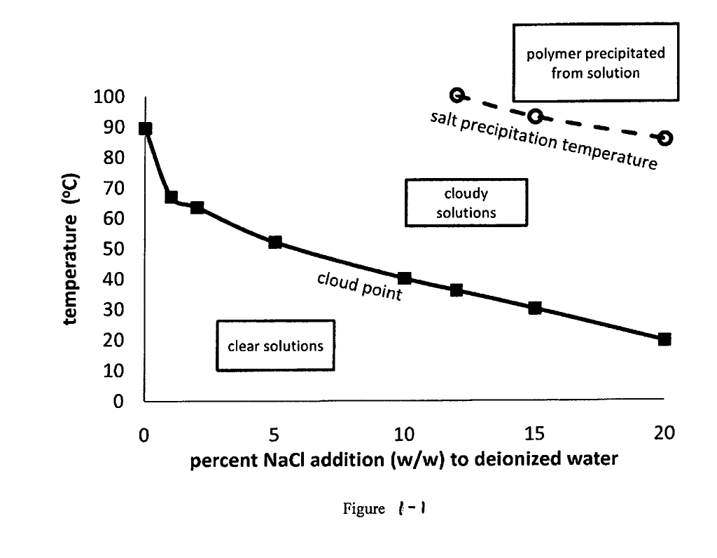

### BACKGROUND OF THE INVENTION

1. Field of the Invention

The invention relates to polymers that exhibit gas hydrate inhibition, salt tolerance, and high cloud points. These polymers and compositions thereof find application in any number of fields where performance in high temperature applications without precipitation is desired, especially applications where salt concentrations may otherwise compromise polymer properties. In one embodiment, the polymers find use during petrochemicals drilling, production and transportation operations.

2. Description of Related Art

The extraction and fluid transport of oil and natural gas present many challenges. Of primary concern in this invention is the inhibition of gas hydrate formation, especially in the harsh environments typical for these operations, which may be land- or ocean-based. It is well known that the presence of water in the hydrocarbon-containing line can facilitate the formation of gas hydrate crystals, which can block the conduit and/or compromise the integrity of the construction materials. Lower molecular weight hydrocarbon gases, such as methane, ethane, propane, butane, and isobutane, are especially prone to the formation of gas hydrates.

The prior art discloses kinetic inhibitors of gas hydrates, for which polymeric compositions have proved especially beneficial. Representative compositions include those disclosed in the following U.S. Pat. Nos. 4,915,176; 5,420,370; 5,432,292; 5,639,925; 5,723,524; 6,028,233; 6,093,863; 6,096,815; 6,117,929; 6,451,891; and 6,451,892. Many of these compositions comprise cyclic ring members, such as lactam rings.

More specifically, polymers having N-vinyl-2-caprolactam, 2-acrylamido-2-methylpropane sulfonic acid (AMPS), acrylamide (AM), and/or N-vinyl-2-pyrrolidone (VP) repeating units are taught in U.S. Pat. Nos. 4,578,201; 4,764,574; 5,639,925; 5,789,635; 5,880,319; 6,030,928; 6,194,622; 6,225,429; 6,380,137; 6,414,075; 6,894,007; and 7,098,171.

N-vinyl formamide homopolymers or copolymers thereof are taught as gas hydrate inhibitors in WO 99/64717 and in copending application PCT/US09/64299.

A description of reaction solvents is provided in U.S. Pat. No. 6,451,891, wherein solvents include low molecular weight glycol ethers containing an alkoxy group having at least three carbon atoms. US patent application 2003/0018152 discloses a method for producing polymers with a solvent for monomers and a second, different solvent for polymerization.

Inhibitors of clathrate hydrates are the object of US patent application 2006/0205603. The polymeric clathrate hydrate inhibitors possess a bimodal distribution in molecular weight of a water-soluble polymer.

The prior art teaches a trade-off between kinetic hydrate inhibition performance and cloud point temperature. For example, polyvinylpyrrolidone homopolymer, which contains a plurality of five-member lactam rings, possesses a cloud point temperature in excess of 100° C., but is a poor kinetic hydrate inhibitor. Known non-homopolymers of N-vinyl-2-pyrrolidone can offer improved kinetic hydrate inhibition, but may possess a lower cloud point than PVP homopolymer. Additionally, attaining high polymer solubility in aqueous salt solutions is a special challenge, especially while maintaining gas hydrate inhibition and cloud point.

### SUMMARY OF THE INVENTION

Provided are polymers that exhibit gas hydrate inhibition, salt tolerance, and high cloud point. Unlike polymers known in the art, those of the instant invention are polymerized from at least (A) 50 mole percent or more of a monomer selected from the group consisting of: N-vinyl-2-caprolactam or one of its analogues, (B) an alkenyl sulfonic acid monomer, salt thereof, or combinations thereof, and (C) an N-vinyl amide, (meth)acrylamide or one of its analogues, or combinations thereof. In one embodiment, the (A) monomer is N-vinyl-2-caprolactam, the (B) monomer is 2-acrylamido-2-methylpropane sulfonic acid or salt thereof, and the (C) monomer is N-vinyl-2-pyrrolidone, acrylamide, methacrylamide, or combinations thereof.

The gas hydrate inhibition performance of these polymers, along with high temperature and salt tolerance lends these polymers in application near the petrochemicals wellhead, where the hottest temperatures are experienced, without resulting in polymer precipitation. Polymer activity for hydrate inhibition is maintained as the mixture cools to temperatures where hydrates may have a tendency to form.

### BRIEF DESCRIPTION OF THE FIGURES

The FIGURE is a phase diagram of temperature versus NaCl addition for a polymer produced in accordance with the invention as described in Example 20.

### DETAILED DESCRIPTION

The term “monomer” refers to a repeating structural unit of a polymer. A monomer is a low molecular weight compound that can form covalent chemical bonds with itself and/or with other monomers, resulting in a polymer.

The term “polymer” refers to a compound comprising repeating structural units (monomers) connected by covalent chemical bonds. The definition includes oligomers. Polymers may be further functionalized after polymerization, for example, by hydrolysis, crosslinking, grafting, or end-capping. Non-limiting examples of polymers include copolymers, terpolymers, quaternary polymers, and homologues. A polymer may be a random, block, or an alternating polymer, or a polymer with a mixed random, block, and/or alternating structure. Polymers may further be associated with solvent adducts.

The term “solvent adduct” refers to one or more solvent molecules bonded to a compound such as a polymer by one or more covalent bonds, ionic bonds, hydrogen bonds, coordinate covalent bonds, and/or Van der Waals forces of attraction.

The term “homopolymer” refers to a polymer consisting essentially of a single type of repeating structural unit (monomer). The definition includes homopolymers with solvent adducts.

The term “non-homopolymer” refers to a polymer having more than one type of repeating structural units (monomers). The definition includes non-homopolymers with solvent adducts.

The term “copolymer” refers to a polymer consisting essentially of two types of repeating structural units (monomers). The definition includes copolymers having solvent adducts.

The term “terpolymer” refers to a polymer consisting essentially of three types of repeating structural units (monomers). The definition includes terpolymers having solvent adducts.

The structure represented as:

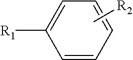

indicates the generic group R₂ (which can represent any group for this definition) can be attached at the ortho, meta, or para positions on the aromatic ring with respect to the generic group R₁ (which can represent any group for this definition).

The term “branched” refers to any non-linear molecular structure. To avoid any arbitrary delineation, the term “branched” describes both branched, hyper-branched, comb, and dendritic structures.

The term “analogue” refers to any compound having a corresponding chemical structure to the named parent compound. Typically, the structure of the analogue compound essentially comprises the patent compound with one or more atoms or groups replaced by another atom or group. For example, non-limiting analogues of N-vinyl-2-pyrrolidone (parent compound) include its alkylated variants such as N-vinyl-3-methyl-2-pyrrolidone. Likewise, non-limiting analogue compounds of (meth)acrylamide (parent compound) include N,N-dialkyl (meth)acrylamide compounds.

The term “free radical addition polymerization initiator” refers to a compound used in a catalytic amount to initiate a free radical addition polymerization. The choice of an initiator depends mainly on its solubility and decomposition temperature.

The term “hetero atom” refers to an atom other than carbon such as oxygen, nitrogen, sulfur, or phosphorus.

The term “halogen” refers to chloro, bromo, iodo or fluoro.

The terms “gas hydrate inhibitor” and “clathrate inhibitor” refer to compounds that exhibit thermodynamic and/or kinetic inhibition of gas hydrates (clathrates).

The term “personal care composition” refers to a composition intended for use on or in the human body and may be an oral care composition, a hair care composition, a hair styling composition, a face care composition, a lip care composition, an eye care composition, a foot care composition, a nail care composition, a sun care composition, a deodorant composition, an antiperspirant composition, a cosmetic composition (including color cosmetics), a skin cleaning composition, an insect repellant composition, a shaving composition, a toothpaste, a mouthwash, a tooth whitener, a tooth stain remover, and/or a hygiene composition. Among their many uses, hair care and hair styling compositions find application in enhancing hair shine, cleansing hair, conditioning hair, repairing split ends, enhancing hair manageability, modulating hair stylability, protecting hair from thermal damage, imparting humidity resistance to hair and hair styles, promoting hair style durability, changing the hair color, straightening and/or relaxing hair, and/or providing protection from UV-A and/or UV-B radiation. Other personal care compositions, such as those for skin care and sun care compositions, are useful for protecting from UV-A and/or UV-B radiation, imparting water resistance or water proofness, moisturizing skin, decreasing and/or minimizing the appearance of wrinkles, firming skin, decreasing or minimizing the appearance of skin blemishes (such as lentigo, skin discolorations, pimples, or acne), changing skin color (such as color cosmetics for the face, cheeks, eyelids, or eye lashes). Oral care compositions according to the invention may be used as denture adhesives, toothpastes, mouthwashes, tooth whiteners, and/or stain removers. Personal care compositions also are used for delivering an active (such as to the skin, hair, or oral cavity).

The term “performance chemicals composition” refers to a non-personal care composition that serves a broad variety of applications, non-limiting examples of which include: adhesives, agricultural, biocides, veterinary, coatings, electronics, household-industrial-institutional (HI&I), inks, membranes, metal fluids, oilfield, paper, paints, plastics, printing, plasters, textiles, fuels, lubricants, home care, and wood care compositions.

The term “functionalized and unfunctionalized alkyl, cycloalkyl, alkenyl, and aryl groups” refers to each of the alkyl, cycloalkyl, alkenyl, and aryl groups that may be substituted or unsubstituted. The substituted or unsubstituted groups may further contain one or more hetero atoms and/or halogen atoms. The alkyl and alkenyl groups may be branched or unbranched (straight-chain). Particularly, the alkyl and alkenyl groups are C1-C60, more particularly C1-C36, and yet more particularly C1-C18 groups. Cycloalkyls include cyclopentane, cyclohexane, cycloheptane, and the like. Aryl groups include benzene, naphthalene, anthracene, and the like, and heteroaryl groups include pyridine, imidazole, and the like.

All percentages, ratios, and proportions used herein are on weight basis unless otherwise specified.

A new class of gas hydrate inhibitors has been discovered that resolves deficiencies of low cloud point and poor salt tolerance noted in known gas hydrate inhibitors, yet also provides excellent inhibition of hydrates. These gas hydrate inhibitors comprise a non-homopolymer polymerized from at least: (A) 50 mole percent or more of a monomer selected from the group consisting of: N-vinyl-2-caprolactam, one of its analogues, and combinations thereof, (B) an alkenyl sulfonic acid monomer, salt thereof, or combinations thereof, and (C) an N-vinyl amide, (meth)acrylamide or one of its analogues, or combinations thereof. In one embodiment the polymer is a terpolymer of N-vinyl-2-caprolactam, the sodium salt of 2-acrylamido-2-methylpropane sulfonic acid, and N-vinyl-2-pyrrolidone, or is a terpolymer of N-vinyl-2-caprolactam, the sodium salt of 2-acrylamido-2-methylpropane sulfonic acid, and (meth)acrylamide.

The repeating monomer unit designated as N-vinyl-2-caprolactam or a analogue thereof is a monomer may be represented by the structure:

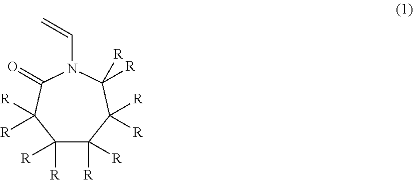

wherein: each R is independently selected from the group consisting of hydrogen, functionalized and unfunctionalized alkyl, cycloalkyl, and aryl groups, wherein any of the aforementioned groups may be present with or without one or more heteroatoms.

The repeating monomer referred to as an alkenyl sulfonic acid monomer or salt thereof, may be represented by the structure:

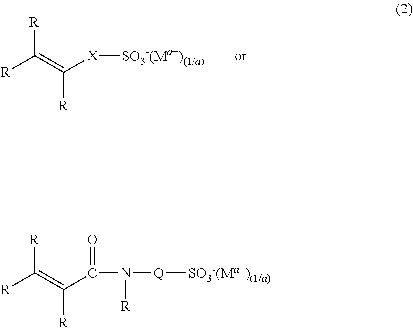

wherein: M is selected from the group consisting of H, Na⁺, K⁺, Li⁺, Ca⁺⁺, Ba⁺⁺, Mg⁺⁺, Al⁺⁺⁺, NH₄⁺, and combinations thereof; and a is equal to the valence of M; Q is selected from the group consisting of: a functionalized and unfunctionalized alkyl, aryl, and cycloalkyl groups, wherein any of the beforementioned groups may be with or without one or more heteroatoms; each R is independently selected from the group consisting of hydrogen, functionalized and unfunctionalized alkyl, cycloalkyl, and aryl groups, wherein any of the aforementioned groups may be present with or without one or more heteroatoms; X is selected from the group consisting of: a direct bond, functionalized and unfunctionalized alkyl, cycloalkyl, and aryl groups, wherein any of the aforementioned groups may be present with or without one or more heteroatoms.

The final repeating monomer unit of the invented polymer is an N-vinyl amide, or an (meth)acrylamide or one of its analogues, the latter category can be represented by the structure:

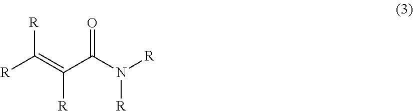

or combinations thereof. Each R in (3) is independently selected from the group consisting of hydrogen and functionalized and unfunctionalized alkyl, cycloalkyl, and aryl groups, wherein any of the beforementioned groups may be present with or without heteroatoms. By the definition of R, one will recognize that the structure shown in (3) includes acrylamide, methacrylamide, and analogues of each.

U.S. Pat. No. 6,194,622 actually instructs away from gas hydrate inhibition polymers comprising AMPS or salt thereof. In the '622 patent the importance of the hydrophilic/hydrophobic balance of the “surfactant mer-unit” is given in column 9, lines 20 through 27. It teaches, “If the inhibitor is too hydrophilic, due to a hydrophobic chain that is too short, the inhibitor will exhibit a subcooling that is too low for the material to be a good inhibitor, or may even promote hydrate formation.” Accompanying this discussion is a structure of an AMPS-like “surfactant mer-unit” with the hydrophobic tail clearly annotated:

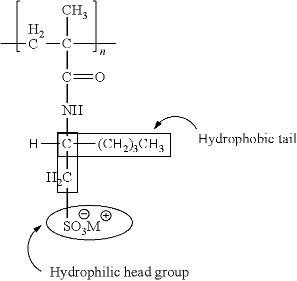

The hydrophobic tail of this monomer contains the propylene group, —(CH₂)₃—, and is clearly more hydrophobic than the corresponding tail in AMPS, which lacks that propylene group. In fact, the '622 patent teaches a gas hydrate inhibitor terpolymer having the formula:

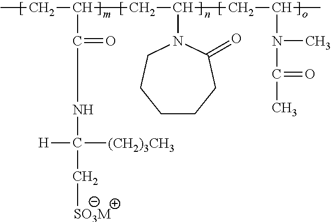

wherein M is sodium. In that terpolymer the first unit on the left is not 2-acrylamido-2-methylpropane sulfonic acid, but rather the more hydrophobic 2-acrylamido-1-hexanesulfonic acid. From the discussion embraced by the '622 patent, 2-acrylamido-2-methylpropane sulfonic acid (or its sodium salt) is shown to be too hydrophilic to be polymerized with VCL and N-methyl-N-vinylacetamide to produce an effective polymeric gas hydrate inhibitor.

Additionally, comparative example 10F of U.S. patent '622 is the terpolymer poly(22% VCL:49% AMPS:29% VP) (molar ratios). However, the salt tolerance of that terpolymer is not provided.

Greater description now will be provided for these at least three repeating units that comprise the invention's polymers.

N-vinyl-2-caprolactam and Analogues Thereof.

As described by structure (1), the polymer is polymerized from at least one N-vinyl-2-caprolactam or a analogue thereof. One choice for this monomer is N-vinyl-2-caprolactam, in which each R of structure (1) is H.

### Alkenyl Sulfonic Acid Monomers and Analogues Thereof.

Returning to the generic structure (2), polymers of the invention also are polymerized from polymerizable alkenyl sulfonic acids, their salts, and analogues thereof. Of primary interest is the group designated as X, which may be a direct bond, functionalized and unfunctionalized alkyl, aryl, and cycloalkyl groups, wherein any of the aforementioned groups may be present with or without one or more heteroatoms.

Without being bound by theory, it appears that the alkenyl sulfonic acid monomer helps to contribute to the salt tolerance properties of the polymer product. As will be discussed later, the type and amount of this alkenyl sulfonic acid monomer, salts thereof, or combinations thereof, may be balanced by the type and amount of N-vinyl amide or (meth)acrylamide or one of its analogues in order to maintain water solubility of the polymer, gas hydrate inhibition, and salt tolerance.

For example, the alkenyl sulfonic acids and salts thereof may include the following compounds:

p-vinylbenzyl sulfonic acid, and salts thereof:

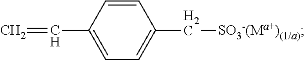

vinyl sulfonic acid and salts thereof:

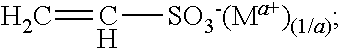

2-acrylamido-2-methylpropane sulfonic acid and salts thereof:

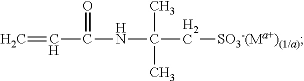

styrene sulfonic acid and salts thereof:

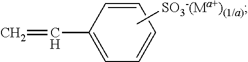

vinyl toluene sulfonic acid, and salts thereof:

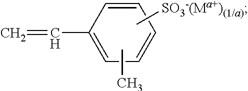

and 1-nitroethylene sulfonic acid, and salts thereof:

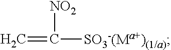

For each of the above alkenyl sulfonic acid formulas, M is selected from the group consisting of H, Na⁺, K⁺, Li⁺, Ca⁺⁺, Ba⁺⁺, Mg⁺⁺, Al⁺⁺⁺, and NH₄⁺; and a is equal to the valence of M.

A further example is the class of compounds known as N-sulfohydrocarbon-substituted (meth)acrylamides, such as those taught in U.S. Pat. No. 3,679,000, which is incorporated herein its entirety by reference. In one aspect, this compound is 2-acrylamido-2-methylpropane sulfonic acid or its salts, which are sold into commercial sale under the trade name AMPS by The Lubrizol Corporation (Wickliffe, Ohio).

Also suitable is 2-acrylamido-2-methylpropane phosphonic acid or its salts (having the same M as defined above). These vinyl phosphonic acid polymers can be prepared as described in German Offenlengungsschrift DE 3,210,775, which is hereby incorporated in its entirety by reference.

### N-Vinyl Amide, (Meth)Acrylamide or One of its Analogues, Analogues Thereof, and Combinations Thereof.

One skilled in the art recognizes N-vinyl amides may be acyclic or cyclic, the latter molecules being referred to as N-vinyl lactams. A subset of N-vinyl lactams are those having the structure:

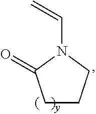

wherein y has a value of 1 or 2. These N-vinyl lactams are generally known as N-vinyl-2-pyrrolidone and N-vinyl-2-piperidone, and use of their analogues also is contemplated.

Examples of cyclic N-vinyl amides include: N-vinyl-2-pyrrolidone, N-vinyl-2-piperidone, N-vinyl-3-methyl-2-pyrrolidone, N-vinyl-3-methyl-2-piperidone, N-vinyl-4-methyl-2-pyrrolidone, N-vinyl-5-methyl-2-pyrrolidone, N-vinyl-5-methyl-2-piperidone, N-vinyl-5,5-dimethyl-2-pyrrolidone, N-vinyl-3,3,5-trimethyl-2-pyrrolidone, N-vinyl-5-methyl-5-ethyl-2-pyrrolidone, N-vinyl-3,4,5-trimethyl-3-ethyl-2-pyrrolidone, N-vinyl-6-methyl-2-piperidone, N-vinyl-6-ethyl-2-piperidone, N-vinyl-3,5-dimethyl-2-piperidone, and N-vinyl-4,4-dimethyl-2-piperidone.

Examples of acyclic N-vinyl amides include: N-vinyl formamide, N-vinyl-N-methyl formamide, N-vinyl-N-ethyl formamide, N-vinyl-N-(n-propyl)formamide, N-vinyl-N-isopropyl formamide, N-vinyl acetamide, N-methyl-N-vinylacetamide, N-ethyl-N-vinylacetamide, N-(n-propyl)-N-vinylacetamide, N-isopropyl-N-vinylacetamide, N-vinyl propionamide, N-vinyl-N-methyl propionamide, N-vinyl-N-ethyl propionamide, N-vinyl-N-(n-propyl)propionamide, N-vinyl-N-isopropyl propionamide, N-vinyl butanamide, N-vinyl-N-methyl butanamide, N-vinyl-N-ethyl butanamide, N-vinyl-N-(n-propyl)butanamide, N-vinyl-N-isopropyl butanamide, analogues thereof, and combinations thereof.

Alternatively, the non-homopolymers of the invention may comprise a (meth)acrylamide or one of its analogues, such as those represented by structure (3). Like their N-vinyl amide counterparts, (meth)acrylamide and its analogues include acyclic and cyclic compounds. As defined herein, structure (3) is taken to encompass both acyclic and cyclic (meth)acrylamides structural forms, wherein —N(R)(R) may be part of a ring.

Non-limiting examples of (meth)acrylamide or one of its analogues having a ring structure include N-acryloylpyrrolidine, N-acryloylpiperidine, N-hexamethyleneimine, and N-acryloylmopholine.

Other examples of (meth)acrylamides and analogues thereof include: (meth)acrylamide, N-methyl (meth)acrylamide, N-ethyl (meth)acrylamide, N-(n-propyl)(meth)acrylamide, N-isopropyl (meth)acrylamide, N,N-dimethyl (meth)acrylamide, N,N-diethyl (meth)acrylamide, N,N-di(n-propyl)(meth)acrylamide, N,N-diisopropyl (meth)acrylamide, N-methyl-N-ethyl (meth)acrylamide, N-methyl-N-(n-propyl)(meth)acrylamide, N-methyl-N-(isopropyl)(meth)acrylamide, N-ethyl-N-(n-propyl)(meth)acrylamide, N-ethyl-N-(isopropyl)(meth)acrylamide, N-acryloylpyrrolidine, N-acryloylpiperidine, N-acryloylhexamethyleneimine, N-acryloylheptamethyleneimine, N-acryloyloctamethyleneimine, N-methacryloylpyrrolidine, N-methacryloylaziridine, N-methacryloylpiperidine, N-methacryloylhexamethyleneimine, N-methacryloylheptamethyleneimine, N-methacryloyloctamethyleneimine, and combinations thereof.

### Methods of Synthesis

The polymers according to the invention may be readily synthesized by procedures known by those skilled in the art, and include free radical polymerization, emulsion polymerization, ionic chain polymerization, living polymerization, and precipitation polymerization. Free radical polymerization is one polymerization method, e.g., when using water-dispersible and/or water-soluble reaction solvent(s), and is described in “Decomposition Rate of Organic Free Radical Polymerization” by K. W. Dixon (section II in Polymer Handbook, volume 1, 4th edition, Wiley-Interscience, 1999), which is incorporated by reference.

The polymerization reactions of this invention can be performed with and without in a reaction solvent. If a solvent is desired, both water-soluble and water-insoluble reaction solvents may be used, and may be selected based on a number of considerations, such as, but not limited to the final product application. It is even possible to produce the polymer in multiple steps, wherein one type of solvent is used in one step, that solvent removed, and then replace with a different type of solvent.

The system used to deliver the polymer composition may comprise a reaction solvent, a blend of reaction solvents, or the reaction solvent(s) may be removed and a different solvent system used for further reaction and/or delivery.

Examples of reaction solvents include, but are not limited to:
(a) straight-chain, branched, or cyclic alcohols (e.g., n—butanol, tert-butanol, ethanol, methanol, 1-propanol, 2-propanol),
(b) straight-chain, branched, or cyclic difunctional, trifunctional or polyfunctional alcohols (e.g., ethylene glycol, glycerol propylene, glycol),
(c) homologues of ethylene oxide and propylene oxide units (e.g., diethylene glycol, triethylene glycol),
(d) glycol ethers (e.g., 2-butoxyethanol, 2-ethoxyethanol, 2-isopropoxyethanol, 2-methoxyethanol, and 2-propoxyethanol)
(e) straight-chain, branched, or cyclic alkanes (e.g., cyclohexane, isooctane, n-hexane, n-heptane),
(f) alkylbenzenes (e.g., benzene, ethylbenzene, toluene, xylene),
(g) monofunctional and difunctional (alkyl)benzenes (e.g., cresol, phenol, resorcinol),
(h) straight-chain, branched or cyclic aliphatic and aromatic ketones (e.g., acetone, acetophenone, cyclohexanone, methyl ethyl ketone,),
(i) water-soluble organic solvents (e.g., alcohols, dimethylformamide, dimethylacetamide, N-methylpyrrolidone, N-ethylpyrrolidone, dimethyl sulfoxide, furan, tetrahydrofuran),
(j) water-insoluble organic solvent (e.g., alkylbenzenes, straight-chain hydrocarbons, chlorinated hydrocarbons),
(j) natural or synthetic waxes, oils, fats, and emulsifiers which are liquid under the polymerization conditions, both per se and in a mixture with the abovementioned organic solvents or with water, and
(k) water.

In one embodiment of the invention, the described polymer finds use in oilfield applications, e.g., as an inhibitor of gas hydrates. Thus, the composition may present the polymer in a water-dispersible and/or water-soluble reaction solvents. Without being bound to specific theory, it is believed that water-dispersible and/or water-soluble solvents help to improve the effectiveness of the polymer by promoting a greater extension of polymer molecule in solution. In addition, such solvents may help to improve the solubility of the polymer in aqueous solution, and improve the compatibility of the composition at high injection temperature.

Examples of water-dispersible and/or water-soluble reaction solvents include, but are not limited to: alcohols, lactams (N-methylpyrrolidone), glycol ethers (e.g., 2-butoxyethanol, 2-ethoxyethanol, 2-isopropoxyethanol, 2-methoxyethanol, and 2-propoxyethanol), furans (e.g., furan, tetrahydrofuran), and combinations thereof.

In one embodiment the reaction and/or delivery solvents include ethanol and/or 2-propanol when the polymer is employed for gas hydrate inhibition.

A choice for glycol ether is 2-butoxyethanol, which may be employed as a reaction solvent and/or delivery solvent.

In non-water based applications, water-insoluble reaction solvent(s) and/or delivery solvent(s) may be used. Solvents that are water insoluble include, but are not limited to: pure hydrocarbons, meaning those compounds consisting entirely of only carbon and hydrogen (e.g., benzene, cyclohexane, heptane, hexane, octane, toluene, and xylene), and impure hydrocarbons, meaning those compounds consisting of carbon, hydrogen, and other bonded atoms (e.g., chloroform, and dichloromethane).

In one embodiment of the invention, the reaction solvent also is employed for delivery. Alternatively, the polymer is produced in one solvent, that solvent removed, and then another solvent or combinations of solvents added.

It is recognized that during the polymerization step (described below), an amount of the reaction solvent may be bonded into the product, viz., incorporated into the polymer as a solvent adduct. Such a solvent adduct is possible with the described water-soluble reaction solvents. The existence of such an adduct can be provided by ¹³C NMR studies.

Again not to be bounded by theory, it is also believed that the solvent adduct may impart surfactant-like properties to cause an extended polymer conformation in solution, which presumably exposes more of the polymer molecule to interact with the hydrate crystal lattice.

### Polymerization and Grafting

Methods to produce the polymers are known to one skilled in the art, and include solution polymerization, solution polymerization followed by inversion, emulsion polymerization, ionic chain polymerization, and precipitation polymerization, the methods of which are known to one skilled in the art. Free radical polymerization may be used, especially when using water-dispersible and/or water-soluble reaction solvent(s), and is described in “Decomposition Rate of Organic Free Radical Polymerization” by K. W. Dixon (section II in Polymer Handbook, volume 1, 4^{th} edition, Wiley-Interscience, 1999), which is incorporated by reference.

Compounds capable of initiating the free-radical polymerization include those materials known to function in the prescribed manner, and include the peroxo and azo classes of materials. Peroxo and azo compounds used in this manner include, but are not limited to: acetyl peroxide; azo bis-(2-amidinopropane) dihydrochloride; azo bis-isobutyronitrile; 2,2′-azo bis-(2-methylbutyronitrile); benzoyl peroxide; di-tert-amyl peroxide; di-tort-butyl diperphthalate; butyl peroctoate; tert-butyl dicumyl peroxide; tert-butyl hydroperoxide; tert-butyl perbenzoate; tent-butyl permaleate; tert-butyl perisobutylrate; tert-butyl peracetate; tert-butyl perpivalate; para-chlorobenzoyl peroxide; cumene hydroperoxide; diacetyl peroxide; dibenzoyl peroxide; dicumyl peroxide; didecanoyl peroxide; dilauroyl peroxide; diisopropyl peroxodicarbamate; dioctanoyl peroxide; lauroyl peroxide; octanoyl peroxide; succinyl peroxide; and bis-(ortho-toluoyl)peroxide.

Also suitable to initiate the free-radical polymerization are initiator mixtures or redox initiator systems, including: ascorbic acid/iron (II) sulfate/sodium peroxodisulfate, tert-butyl hydroperoxide/sodium disulfite, and tert-butyl hydroperoxide/sodium hydroxymethanesulfinate.

In one synthesis method, the described polymer is produced using a one-step technique. A one-step method may facilitate production ease, as the reactants (including initiator) can be charged into the reaction vessel in one campaign. As an illustration of this method, a premix of N-vinyl-2-caprolactam, AMPS, and N-vinyl-2-pyrrolidone in the proper ratios, and ethylene glycol can be prepared and pH-adjusted to 10 using NaOH. Afterwards, the premix is charged into a reactor with tert-butyl peroxypivalate (or other initiator) to synthesize poly(VCL-NaAMPS-VP).

Alternatively, monomer units may be polymerized co-currently together, using an appropriate initiator and optional solvent(s). Alternatively, the polymerization reaction may be initiated with one or more of the monomers, the reaction temporarily slowed or stopped, and then reinitiated upon the addition of more or different monomers and initiator.

By yet another method, it may be desirable to employ polar and/or aprotic solvent(s) (e.g., tetrahydrofuran, dimethylsulfoxide, dimethylformamide, or toluene) as the reaction solvent. Furthermore, it may be advantageous to remove the reaction solvent from the first step (e.g., ethanol) to achieve high product yield from the second step. Solvent removal may performed using a vacuum oven with an appropriate temperature setting. Alternatively, solvent removal can be performed using azeotropic distillation with an inert solvent, such as toluene, xylene analogues or heptane analogues, prior to the second step.

The inventive copolymers of the present invention may be prepared using emulsion polymerization, solution polymerization followed by an inversion step, and suspension polymerization. The methods use initiators that, through various techniques, are decomposed to form free radicals. Once in their radical form, the initiators react with the monomers starting the polymerization process.

The initiators are often called “free radical initiators.” Various decomposition methods of the initiators are discussed first, followed by a description of the emulsion, solution, and suspension polymerization methods. The initiator can be decomposed homolytically to form free radicals. Homolytic decomposition of the initiator can be induced by using heat energy (thermolysis), using light energy (photolysis), or using appropriate catalysts. Light energy can be supplied by means of visible or ultraviolet sources, including low intensity fluorescent black light lamps, medium pressure mercury arc lamps, and germicidal mercury lamps.

Catalyst induced homolytic decomposition of the initiator typically involves an electron transfer mechanism resulting in a reduction-oxidation (redox) reaction. This redox method of initiation is described in Elias, Chapter 20 (detailed below). Initiators such as persulfates, peroxides, and hydroperoxides are more susceptible to this type of decomposition. Useful catalysts include, but are not limited to, (1) amines, (2) metal ions used in combination with peroxide or hydroperoxide initiators, and (3) bisulfite or mercapto-based compounds used in combination with persulfate initiators.

Useful initiators are described in Chapters 20 & 21 Macromolecules, Vol. 2, 2nd Ed., H. G. Elias, Plenum Press, 1984, New York. Useful thermal initiators include, but are not limited to, the following: (1) azo compounds such as 2,2-azo-bis-(isobutyronitrile), dimethyl 2,2′-azo-bis-isobutyrate, azo-bis-(diphenyl methane), 4-4′-azo-bis-(4-cyanopentanoic acid); (2) peroxides such as benzoyl peroxide, cumyl peroxide, tert-butyl peroxide, cyclohexanone peroxide, glutaric acid peroxide, lauroyl peroxide, methyl ethyl ketone peroxide; (3) hydrogen peroxide and hydroperoxides such as tert-butyl hydroperoxide and cumene hydroperoxide; (4) peracids such as peracetic acid and perbenzoic acid; potassium persulfate; ammonium persulfate; and (5) peresters such as diisopropyl percarbonate.

Useful photochemical initiators include but are not limited to benzoin ethers such as diethoxyacetophenone, oximino-ketones, acylphosphine oxides, diaryl ketones such as benzophenone and 2-isopropyl thioxanthone, benzyl and quinone analogues, and 3-ketocoumarins as described by S. P. Pappas, J. Rad. Cur., July 1987, p. 6.

Now, some of the various polymerization methods are summarized that may be employed to synthesize the polymer.

### Solution Polymerization and Optional Inversion

The non-homopolymers of the present invention can be made by solution polymerization followed by an optional inversion step. In one illustrative solution polymerization method, the monomers and suitable inert solvents are charged into a reaction vessel. The monomers and the resultant copolymers are soluble in the solvent. After the monomers are charged, an initiator, e.g., a thermal free radical initiator is added. The vessel is purged with nitrogen to create an inert atmosphere. The reaction may be allowed to proceed, typically using elevated temperatures, to achieve a desired conversion of the monomers to the copolymer. In solution polymerization, the initiator used may comprise a thermally decomposed azo or peroxide compound for reasons of solubility and control of the reaction rate.

Suitable solvents for solution polymerizations include but are not limited to (1) esters such as ethyl acetate and butyl acetate; (2) ketones such as methyl ethyl ketone and acetone; (3) alcohols such as methanol and ethanol; (4) aliphatic and aromatic hydrocarbons; and mixtures of one or more of these. The solvent, however, may be any substance which is liquid in a temperature range of about −10° C. to 50° C., does not interfere with the energy source or catalyst used to dissociate the initiator to form free radicals, is inert to the reactants and product, and will not otherwise adversely affect the reaction. The amount of solvent, when used, is generally about 30% to 80% (w/w) based on the total weight of the reactants and solvent. The amount of solvent can range from about 40% to 65% (w/w), based upon the total weight of the reactants and solvent, to yield fast reaction times.

Non-homopolymers prepared by solution polymerization optionally can be inverted to yield dispersions of small average particle size, typically less than about 1 μm, for example, less than about 0.5 μm.

The non-homopolymer may be prepared in a water-miscible solvent which has a boiling point below 100° C. such as ethylene glycol. Alternatively, a non-water-miscible polymerization solvent such as ethyl acetate may be used. The non-water-miscible polymerization solvent may be removed from the copolymer by using a rotary evaporator. The resulting copolymer can then be dissolved in a water-miscible solvent such as those described above or mixtures including isopropanol, methanol, ethanol, and tetrahydrofuran.

The resulting solutions may be added with stirring to an aqueous solution of a base, (in the case of non-homopolymers containing acidic functionality), or an acid (in the case of copolymers containing basic functionality). Alternatively, the base or acid can be added to the polymer solution prior to adding water or adding to water. Suitable bases include (1) ammonia and organic amines, such as aminomethyl propanol, triethyl amine, triethanol amine, methyl amine, morpholine, and (2) metal hydroxides, oxides, and carbonates, etc. Suitable acids include (1) carboxylic acids such as acetic acid, and (2) mineral acids, such as HCl. In the case of a volatile weak base (e.g., ammonia) or acid (e.g., acetic acid), the ionic group formed (an ammonium carboxylate) is non-permanent in nature. For example, for an acrylic acid containing polymer neutralized with aqueous ammonia, the polymer remains as the ammonium acrylate analogue when dispersed in water, but is thought to revert to its original free acid state as the coating dries on the surface. This is because there is an equilibrium between the neutralized and free acid which is shifted towards the free acid as the ammonia is driven off on drying. Acid or base at less than an equivalent may be used, more particularly at slightly less than an equivalent, to ensure near neutral pH.

### Suspension Polymerization

The non-homopolymers of the present invention can be made by a suspension polymerization method in the absence of surfactants. Instead, colloidal silica in combination with a promoter may be used as the stabilizer. Using this process, surfactant-free copolymers can be obtained with a relatively narrow particle size distribution. The method involves making a monomer premix comprising the first, second, and optionally third monomer. The premix is combined with a water phase (e.g., deionized water), containing colloidal silica, and a promoter. Amphiphilic polymers represent one class of useful promoters.

The pH of the mixture is adjusted so as to be in the range of 3 to 11, particularly in the range of 4 to 6, without coagulation of the particles. For certain monomers, the initial pH of the mixture can be as low as about 2.5. This pH is low enough for the colloidal silica to stabilize the monomer droplet, but the final product may contain a small amount of coagulum. Similar observation can be made at very high pH. It has been observed that when the mixture is treated with ammonia or hydrochloric acid to about pH 4 to 6, the reaction is more stable and the final product is basically free of coagulum.

The mixture may be exposed to high shear, such as that capable in a Waring™ blender, to break the monomer droplets down to a diameter size of 1 micrometer or less. The shearing action is then reduced to a lower agitation (or temporarily stopped) to allow for the partial coalescence of the small droplets and formation of a suspension. Initiator is added. The silica-promoter mixture stabilizes the droplets and limits their coalescence yielding very uniform, and sometimes nearly monodisperse particles. The suspension polymerization is completed under moderate agitation and a stable, aqueous dispersion is obtained.

The above described suspension polymerization has several advantages. For example, the method yields a copolymer with a narrow distribution of mean particle size and limited coalescence. When coalescence is present, the particles tend to migrate towards one another and can form large masses. Coalescence hampers the handling and transportation of the particles and thus is undesirable. The particles are sterically stabilized by the colloidal silica.

### Emulsion Polymerization

The non-homopolymers of the present invention can be made by emulsion polymerization. In general, it is a process where the monomers are dispersed in a continuous phase (typically water) with the aid of an emulsifier and polymerized with the free-radical initiators described above. Other components that are often used in this process include stabilizers (e.g., copolymerizable surfactants), chain transfer agents for minimizing and/or controlling the polymer molecular weight, and catalysts. The product of this type of polymerization is typically a colloidal dispersion of the polymer particles, often referred to as “latex.” In one emulsion polymerization process, a redox chemistry catalyst, such as sodium metabisulfite, used in combination with potassium persulfate initiator and ferrous sulfate heptahydrate, is used to start the polymerization at or near room temperature. Typically, the copolymer particle size is less than one μm, particularly less than 0.5 μm.

Emulsion polymerization can be carried out in several different processes. For example, in a batch process the components are charged into the reactor at or near the beginning. In a semi-continuous process, a portion of the monomer composition is initially polymerized to form a “seed” and the remaining monomer composition is metered in and reacted over an extended time. In one multistage process, a seed polymer of one monomer composition (or one molecular weight distribution) is used to nucleate the polymerization of a second monomer composition (or the same composition with a different molecular weight distribution) forming a heterogeneous polymer particle. These emulsion polymerization techniques are well known by those skilled in the art and are widely used in industry.

### Monomer Proportions and Use Levels

In addition to possessing excellent gas hydrate inhibition the non-homopolymers of the invention also can tolerate high levels of salt and temperature. These properties are attributed in part to synergy achieved from the proper ratios of the at least three repeating units.

First, the polymers of the invention comprise at least 50 mole percent N-vinyl-2-caprolactam, a analogue thereof, or combinations thereof. Without being bound to theory, it is believed that this level of this repeating unit help to promote excellent gas hydrate inhibition. More particularly, the polymers comprise higher levels of 60 mole percent or more, or 70 mole percent or more.

Overall polymer hydrophilicity is attained by selecting appropriate types and amounts of the alkenyl sulfonic acid monomer (or analogues thereof or combinations thereof) and the N-vinyl amide and/or (meth)acrylamide or one of its analogues with the chosen amount and type of the first repeating unit. In one embodiment, overall performance was obtained when the alkenyl sulfonic acid monomer and the N-vinyl amide and/or (meth)acrylamide or one of its analogues are present in about equal molar ratios. The phrase “about equal molar ratios” is defined herein to mean molar ratios that range from 2:1 to 1:2. As illustrated in the Examples, combined overall performance is maintained by polymers comprising these ranges of monomer units.

Polymers produced by this invention comprise at least, by molar ratio:
more than about 50% of an N-vinyl-2-caprolactam (or analogue thereof, or combinations thereof),
an alkenyl sulfonic acid (or analogue thereof or combinations thereof), and
an N-vinyl amide and/or (meth)acrylamide (or analogues thereof or combinations thereof).

Particularly, the polymers comprise, by molar ratio:
from about 50% to about 90% of an N-vinyl-2-caprolactam (or analogue thereof, or combinations thereof),
from about 5% to 25% of at least one alkenyl sulfonic acid (or analogue thereof or combinations thereof), and
from about 5% to about 25% of an N-vinyl amide and/or (meth)acrylamide (or analogues thereof or combinations thereof).

More particularly, the polymers comprise, by molar ratio:
from about 50% to about 90% of an N-vinyl-2-caprolactam (or a analogue thereof, or combinations thereof);
about equal amounts of an alkenyl sulfonic acid (or analogue thereof or combinations thereof) and an N-vinyl amide and/or (meth)acrylamide (or analogues thereof or combinations thereof).

Even more particularly, the polymers comprise, by molar ratio:
from about 60% to about 90% of an N-vinyl-2-caprolactam (or a analogue thereof or combinations thereof);
about equal amounts of an alkenyl sulfonic acid (or analogue thereof or combinations thereof) and an N-vinyl amide and/or (meth)acrylamide (or analogues thereof or combinations thereof).

As one aspect, the invention's polymers include, by molar ratio:
poly[60% to 70% VCL-15% to 20% AMPS (or salt thereof)-15% to 20% VP] and
poly[60% to 70% VCL-15% to 20% AMPS (or salt thereof)-15% to 20% AM].

The aforementioned polymer compositions may have a weight-average molecular weight of about 500 Da (Daltons) to about 5,000,000 Da, as determined by gel permeation chromatography using polyethylene glycol standards. When the polymer is employed in gas hydrate inhibition, the polymer weight-average molecular weight can ranges from about 500 Da to about 100,000 Da.

In oilfield applications any convenient concentration of inhibitor in the delivery fluid (e.g., solvent) can be used, so long as it is effective in its purpose. Generally, the polymeric gas hydrate inhibitor is used in an amount of about 0.1% to about 3% by weight of the water present. The compositions also may include (without limitation) one or more biocides, corrosion inhibitors, emulsifiers, de-emulsifiers, defoamers, lubricants, and/or rheology modifiers. Furthermore, they may be used with other gas hydrate inhibitors.

It is contemplated that higher concentrations may be useful in some applications. For example, at low application temperature high polymer concentrations may be needed to effectively inhibit gas hydrate formation and/or conduit blockage. Other applications may benefit from a reduced volume of concentrate solution, as it may simplify product handling and/or ease introduction into the petroleum fluid. Nonetheless, it is understood that the actual concentration will vary, depending upon many parameters like the specific application and hydrate chemistry, selection of carrier solvent, the chemical composition of the inhibitor, the system temperature, and the inhibitor's solubility in the carrier solvent at application conditions. A suitable concentration for a particular application, however, can be determined by those skilled in the art by taking into account the inhibitor's performance under such application, the degree of inhibition required for the petroleum fluid, and the inhibitor's cost.

Also embraced by the invention is the use of the disclosed polymers in personal care applications, especially for use in hair or skin formulations. Addition levels, coformulary ingredients, products, and product forms include those taught in research disclosures IPCOM 000128968D, available at http://priorartdatabase.com/IPCOM/000128968, and IPCOM 000109682D, available at http://priorartdatabase.com/IPCOM/000109682.

### Polymer Performance

It was discovered that the polymers of this invention exhibit a useful combination of at least three properties-effective gas hydrate inhibition, high cloud point, and excellent salt tolerance. These properties enable the effective application of these polymers and compositions thereof in fields where salt tolerance is encountered such as oil recovery.

The effectiveness of gas hydrate inhibitors can be determined by measuring the time required for hydrate formation of it occurs at all) at a fixed pressure and subcooling temperature, This method is, summarized here, as it, was employed to obtain the results recorded in the Examples section.

Briefly, a stainless steel autoclave fitted with a cooling jacket, sapphire window, and stirring mechanism is loaded with a test solution comprising the gas hydrate inhibitor to be evaluated. Then, the autoclave is closed and pressurized to a constant pressure using a synthetic hydrocarbon gas mixture to an elevated pressure, such as 60 bar, at room temperature. Afterward, under constant stirring and pressure, the autoclave is cooled to achieve a predetermined subcooling temperature, T_{sc}. The subcooling temperature, T_{sc}, is actually a temperature difference:

T_{sc}=Tₛₑₜ−T_{eq}

wherein Tₛₑₜ is the actual set temperature of the autoclave and T_{eq} is the hydrate equilibrium dissociation temperature, which can be estimating for a particular synthetic hydrocarbon gas mixture, e.g., using computer modeling tools such as pvtsim (Calsep A/S, Lyngby, Denmark). After predicting T_{eq}, the above temperature equation is used to determine the Tₛₑₜ needed to achieve a desired T_{sc}. The autoclave is maintained at this Tₛₑₜ and the constant pressure until gas hydrates are detected (if at all). The time for hydrate formation may be determined by any one of three indicators: visual detection of hydrate crystals (i.e., formation of a turbid solution), a decrease in vessel pressure due to gas uptake by the solution to form hydrates, or an increase in solution temperature created by the exothermic gas hydrate reaction.

The polymers of the invention include those for which gas hydrate formation is not detected for 2,880 minutes or more at a subcooling temperature of 10.3° C.

Compositions of the invention also include those that, together with gas hydrate inhibition, exhibit a cloud point of at least about 50° C. The polymers remain completely soluble at temperatures up to the cloud up, so that high cloud points are extremely useful for high-temperature use.

Methods for determining the cloud point of a polymer are known, and include the technique employed in the Examples. Concisely, a solution of the polymer at a given addition level (such as 1% w/w) is prepared in deionized water, and then the solution is slowly heated with stirring while monitoring the solution temperature. The cloud point is the temperature at which the solution exhibits cloudiness or turbidity, and may be determined by visual inspection. More particularly, a 1% (w/w) solution of the disclosed polymers in deionized water have a cloud point of at least 55° C., and yet more particularly, a cloud point of at least 80° C.

In addition to providing effective gas hydrate inhibition and a high (deionized water) cloud point, the inventive polymers are also extremely tolerant of high salt concentrations. Salt tolerance itself is a generic description that encompasses three distinct properties, each of which helps to define the inventive polymer. These useful characteristics are the brine cloud point, the salt precipitation temperature, and the injection temperature. High salt tolerance, as provided by any or all of these three properties, is desired, since the polymer remains in solution without precipitation at the high temperature (such as extreme injection temperatures), allowing it to retain its effectiveness at lower temperatures (such as in conduit transport).

Like their fresh-water counterparts, cloud points can be determined in brines and synthetic sea water, such as those made by adding a salt like sodium chloride (NaCl) to deionized water. In general, due to competing intermolecular bonding effects (such as hydrogen bonding), brine cloud points are lower than the corresponding deionized water value. Yet, polymers of the invention are noted for attaining high brine cloud points. A polymer embraced by this invention provides a cloud point of at least 30° C. for a 1% (w/w) polymer solution in 15% NaCl (w/w basis without added non-homopolymer).

Unlike cloud points, the salt precipitation temperature is the temperature at which the polymer precipitates from solution, for example, as sticky globules that may coat solid surfaces. Depending on the polymer and salt, this precipitation may be a reversible or irreversible phenomenon. At a 0.5% (w/w) addition level polymers of the instant invention include those that do not precipitate at any temperature up to 100° C. in up to 12% (w/w) NaCl. In a brine having 15% (w/w) NaCl, polymers can manifest a salt precipitation temperature of about 90° C. or higher.

A third indicator of polymer performance in brines is the injection temperature. In this method, a syringe is used to rapidly inject an initial concentration of the polymer in deionized water solution into a stirred brine that is fully preheated to a high temperature, such as 85° C. A polymer that successfully passes this high injection temperature test is one that does not precipitate from solution, as evidenced by the lack of globules formation or polymer coating the agitator and/or container.

It will be recognized by one skilled in the art that the three salt tolerance properties are inter-related, and directly attributed, in part, to the polymer composition. Without being bound by theory, the salt tolerance of the polymer is believed to be due to the alkenyl sulfonic acid monomer (or salt thereof) and the N-vinyl amide or (meth)acrylamide or one of its analogues monomer (or combinations thereof). Very closely related, the overall polymer performance with regard to excellent gas hydrate inhibition, cloud point, and injection temperature is also attributed to polymer composition, especially the unique combination of more than 50 mole percent VCL. In different embodiments the performance attributes are attained using about equal molar fractions of the other two named repeating units.

### Polymer Analytical Characterization

The polymers and compositions comprising the polymers according to the invention can be analyzed by known techniques, such as ¹³C nuclear magnetic resonance (NMR) spectroscopy, gas chromatography (GC), and gel permeation chromatography (GPC) in order to decipher polymer identity, residual monomer concentrations, polymer molecular weight, and polymer molecular weight distribution.

Nuclear magnetic resonance (NMR) spectroscopy is a method to probe the polymerization product in terms of chemical properties such as monomeric composition, sequencing and tacticity. Analytical equipment suitable for these analyses includes the Inova 400-MR NMR System by Varian Inc. (Palo Alto, Calif.). References broadly describing NMR include: Yoder, C. H. and Schaeffer Jr., C. D., Introduction to Multinuclear NMR, The Benjamin/Cummings Publishing Company, Inc., 1987; and Silverstein, R. M., et al., Spectrometric Identification of Organic Compounds, John Wiley & Sons, 1981, which are incorporated in their entirety by reference.

Residual monomer levels can be measured by GC, which can be used to indicate the extent of reactant conversion by the polymerization process. GC analytical equipment to perform these tests are commercially available, and include the following units: Series 5880, 5890, and 6890 GC-FID and GC-TCD by Agilent Technologies, Inc. (Santa Clara, Calif.). GC principles are described in Modern Practice of Gas Chromatography, third edition (John Wiley & Sons, 1995) by Robert L. Grob and Eugene F. Barry, which is hereby incorporated in its entirety by reference.

GPC is an analytical method that separates molecules based on their hydrodynamic volume (or size) in solution of the mobile phase, such as hydroalcoholic solutions with surfactants. GPC is a method for measuring polymer molecular weight distributions. This technique can be performed on known analytical equipment sold for this purpose, and include the TDAmax™ Elevated Temperature GPC System and the RImax™ Conventional Calibration System by Viscotek™ Corp. (Houston, Tex.). In addition, GPC employs analytical standards as a reference, of which a plurality of narrow-distribution polyethylene glycol and polyethylene oxide standards representing a wide range in molecular weight may be used. These analytical standards are available for purchase from Rohm & Haas Company (Philadelphia, Pa.) and Varian Inc. (Palo Alto, Calif.). GPC is described in the following texts, which are hereby incorporated in their entirety by reference: Schroder, E., et al., Polymer Characterization, Hanser Publishers, 1989; Billingham, N. C., Molar Mass Measurements in Polymer Science, Halsted Press, 1979; and Billmeyer, F., Textbook of Polymer Science, Wiley Interscience, 1984.

In addition to all of the polymerizable compounds, homopolymers, and non-homopolymers that are described above, the invention also provides for compositions comprising them. These compositions may be adhesive, agricultural, biocide, cleaning, coating, encapsulation, membrane, oilfield, performance chemical, or personal care compositions.

Non-limiting examples of compositions comprising the compounds, homopolymers and non-homopolymers according to the invention include performance chemical compositions and personal care compositions.

The polymers according to the invention can be prepared according to the examples set out below. The examples are presented for purposes of demonstrating, but not limiting, the preparation of the compounds and compositions of this invention:

### EXAMPLES

### Example 1

### Synthesis of Poly(80.9% VCL-9.2% NaAMPS-9.9% AM) (Mole Ratios) in EG

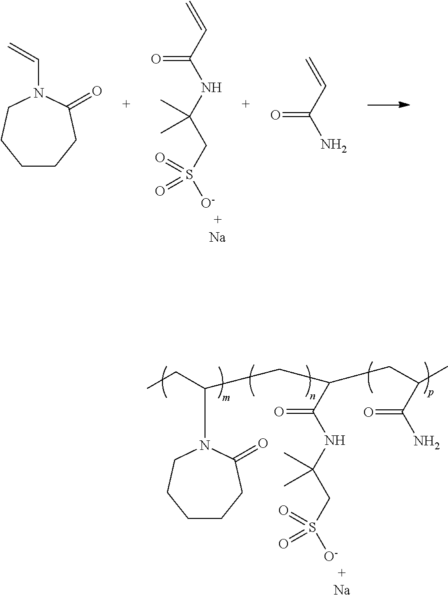

A quantity of 80.0 g of ethylene glycol (EG) was charged into a 1-L resin kettle, fitted with a propeller agitator, a heating mantle, a reflux condenser, nitrogen gas inlet and outlet tubes, and a thermocouple. Then, 60.0 g of N-vinyl-2-caprolactam (VCL), 61.0 g of 2-acrylamido-2-methylpropane sulfonic acid sodium salt (NaAMPS) solution, and 9.5 g of acrylamide (AM), along with an additional 39.5 g of EG were pre-mixed in a 250 mL beaker. After adjusting the pH of this pre-mix solution to 10 using NaOH, 17.0 g were charged into the reactor. Under nitrogen purge and vigorous stirring, the reactor was heated to 102° C., upon which the initiator t-butyl peroxypivalate (Trigonox® 25C75) was charged into the reactor. Then, after 15 minutes, the remaining 153 g of the pre-mix solution was metered into the reactor over a period of 180 minutes. Overall, initiator was charged into the reactor every 15 minutes for 4.0 hours. Afterwards, the reaction temperature was decreased to 92° C. After 4.5 hours the reaction mixture was cooled to room temperature (20° C.-25° C.). A mostly clear solution of the random non-homopolymer in EG was produced. The polymer is a random, alternating, or block polymer. The structural subscripts m, n, and p are integers equal to or greater than 1 such that the number of each monomer unit yields a polymer having a weight-average molecular weight between 500 Da and 5,000,000 Da.

### Examples 2-5

### Synthesis of Other Poly(VCL-NaAMPS-AM) Polymers

Example 1 was substantially repeated four times to produce other poly(VCL-NaAMPS-AM) terpolymers, each with more than 50 molar percent VCL, as summarized in Table 1.

TABLE 1
Poly(VCL-NaAMPS-AM) polymers of Examples 1-6.

| polymer from | polymer molar composition | | |
|---|---|---|---|
| Example | VCL | NaAMPS | AM |
| 1 | 80.9% | 9.2% | 9.9% |
| 2 | 90.5% | 4.6% | 4.9% |
| 3 | 71.7% | 14.3% | 14.0% |
| 4 | 61.4% | 18.6% | 20.0% |
| 5 | 51.8% | 23.9% | 24.3% |

### Example 6

### Polymer Characteristics

HPCL analysis was employed to determine the residual monomer concentration in the polymerized product. Samples were dissolved at 1% (w/w) in deionized water and allowed to sit overnight. The clear solutions thus obtained were filtered using a 0.45 μm cutoff filter, and the filtrate was injected. NaAMPS and AM were not found in the polymers at levels either above the limit of detection or the method quantitation limit, and residual VCL was detected (Table 2).

GPC was employed to determine the polymers' weight-average molecular weight (Mw), which ranged from about 5,710 Da to 6,500 Da (Table 3). Polydispersity indexes for the polymers ranged from 2.80 to 3.90 (Table 3).

The relative viscosities of the polymers were evaluated using ethylene glycol as the standard. The relative viscosities ranged from 1.05 to 1.16 (Table 3).

TABLE 2
Residual monomer concentrations for the poly(VCL-
NaAMPS-AM) terpolymers of Examples 1-5.

| polymer from | polymer molar composition | | | residual monomer (ppm) | | |
|---|---|---|---|---|---|---|
| Example | VCL | NaAMPS | AM | VCL | NaAMPS | AM |
| 1 | 80.9% | 9.2% | 9.9% | 712 | <30.9 | <2.6 |
| 2 | 90.5% | 4.6% | 4.9% | 965 | <30.9 | <2.6 |
| 3 | 71.7% | 14.3% | 14.0% | 415 | <30.9 | <2.6 |
| 4 | 61.4% | 18.6% | 20.0% | 595 | <30.9 | <2.6 |
| 5 | 51.8% | 23.9% | 24.3% | 286 | <30.9 | <2.6 |

TABLE 3
Characteristics of the poly(VCL-NaAMPS-
AM) terpolymers of Examples 1-5.

| polymer from | polymer molar composition | | | M_{w} | | relative |
|---|---|---|---|---|---|---|
| Example | VCL | NaAMPS | AM | (Da) | PDI | viscosity |
| 1 | 80.9% | 9.2% | 9.9% | 6,340 | 3.20 | 1.08 |
| 2 | 90.5% | 4.6% | 4.9% | 6,140 | 3.90 | 1.05 |
| 3 | 71.7% | 14.3% | 14.0% | 7,060 | 3.00 | 1.16 |
| 4 | 61.4% | 18.6% | 20.0% | 5,810 | 2.80 | 1.15 |
| 5 | 51.8% | 23.9% | 24.3% | 5,710 | 2.80 | 1.14 |

### Example 7

### Cloud Point and Salt Precipitation Temperature

Cloud point was measured for the polymers from Examples 1-5. The tests were performed using 1% (w/w) of the polymer in deionized water. The cloud point was determined by visual inspection as the temperature at which the clear solution began to exhibit turbidity. Decreasing the amount of VCL in the terpolymer resulted in lower cloud points. Cloud point decreased from 97° C. for the sample from Example 1, to 48.5° C. for the sample from Example 5 (Table 4).

Likewise, the and salt precipitation temperature also was measured for 1% (w/w water) polymer solutions in deionized water with 15% (w/w) NaCl. Polymer precipitation in this salt solution was determined by visual inspection as the temperature at which the polymer formed globules and/or coated magnetic stirrer or beaker. Like cloud point, decreasing the amount of VCL lowered the salt precipitation temperature, which ranged from 96.5° C. for the sample from Example 1, to 30.0° C. for the sample from Example 5 (Table 4).

TABLE 4
Cloud points and salt precipitation temperatures of
the poly(VCL-NaAMPS-AM) terpolymers of Examples 1-5.

| | | | | cloud | |
|---|---|---|---|---|---|
| polymer from | polymer molar composition | | | point | salt precipitation |
| Example | VCL | NaAMPS | AM | (° C.) | temperature (° C.) |
| 1 | 80.9% | 9.2% | 9.9% | 97.0 | 96.5 |
| 2 | 90.5% | 4.6% | 4.9% | 73.5 | 82.0 |
| 3 | 71.7% | 14.3% | 14.0% | 68.5 | 69.0 |
| 4 | 61.4% | 18.6% | 20.0% | 57.5 | 49.0 |
| 5 | 51.8% | 23.9% | 24.3% | 48.5 | 30.0 |

### Example 8

### Synthesis of Poly(64.7% VCP-17.7% NaAMPS-17.6% VP) (Mole Ratio) in EG

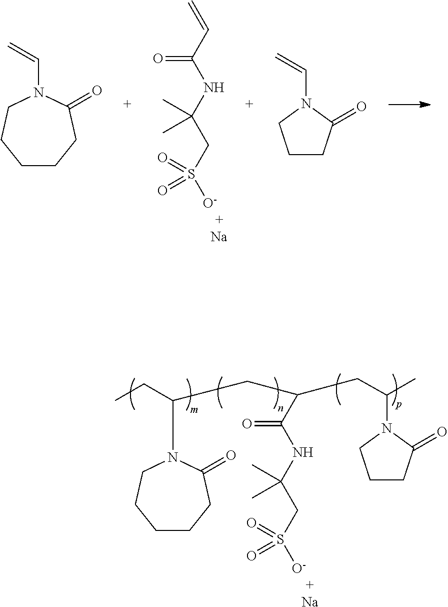

A 1-L resin kettle, fitted with a propeller agitator, a heating mantle, a reflux condenser, nitrogen gas inlet and outlet tubes, and a thermocouple was charged with 10% of a premix consisting of 60.0 g of N-vinyl-2-caprolactam (VCL), 53.8 g of 2-acrylamido-2-methylpropane sulfonic acid sodium salt (NaAMPS) solution, and 13.1 g of N-vinyl-2-pyrrolidone (VP) in 23.1 g of ethylene glycol (EG). The pH of this pre-mix solution was adjusted to 10 using 1 N NaOH. Under nitrogen purge and vigorous stirring, the reactor was heated to 105° C., upon which the initiator t-butyl peroxypivalate (Trigonox® 25C75) was charged into the reactor. Then, after 15 minutes, the remaining 153 g of the pre-mix solution was metered into the reactor over a period of 180 minutes. Overall, initiator was charged into the reactor every 15 minutes for 3.5 hours. Afterwards, the reaction temperature was decreased to 96° C. After 4.5 hours the reaction mixture was cooled to room temperature (20° C.-25° C.). A mostly-clear solution of the random non-homopolymer in EG was produced. The polymer is a random, alternating, or block polymer. The structural subscripts m, n, and p are integers equal to or greater than 1 such that the number of each monomer unit yields a polymer having a weight-average molecular weight between 500 Da and 5,000,000 Da.

### Examples 9-17

### Synthesis of Other Poly(VCL-NaAMPS-VP) Polymers

Example 8 was substantially repeated nine times to produce other poly(VCL-NaAMPS-VP) terpolymers, each with more than 50 molar percent VCL, as summarized in Table 5.

TABLE 5
Poly(VCL-NaAMPS-VP) polymers of Examples 8-17.

| | polymer molar composition | | |
|---|---|---|---|
| Example | VCL | NaAMPS | VP |
| 8 | 64.7% | 17.7% | 17.6% |
| 9 | 64.7% | 17.7% | 17.6% |
| 10 | 64.7% | 17.7% | 17.6% |
| 11 | 64.7% | 17.7% | 17.6% |
| 12 | 64.7% | 17.7% | 17.6% |
| 13 | 64.7% | 17.7% | 17.6% |
| 14 | 73.9% | 12.8% | 13.2% |
| 15 | 61.7% | 12.5% | 25.8% |
| 16 | 61.7% | 12.5% | 25.8% |
| 17 | 66.1% | 20.1% | 13.8% |

### Example 18

### Molecular Weight and Polydispersity Index of Poly(VCL-NaAMPS-VP)

The weight-average molecular weights, polydispersity indexes (PDI), and relative viscosities were measured for the polymers produced in Examples 8-10 and 14 (Table 6). The methods were the same as described in Example 3.

TABLE 6
Residual monomer concentrations for the poly(VCL-
NaAMPS-VP) terpolymers of Examples 8-10 and 14.

| polymer from | polymer molar composition | | | M_{w} | | relative |
|---|---|---|---|---|---|---|
| Example | VCL | NaAMPS | VP | (Da) | PDI | viscosity |
| 8 | 64.7% | 17.7% | 17.6% | 7180 | 3.00 | 1.14 |
| 9 | 64.7% | 17.7% | 17.6% | 7790 | 2.70 | 1.16 |
| 10 | 64.7% | 17.7% | 17.6% | 6000 | 2.50 | 1.08 |
| 14 | 73.9% | 12.8% | 13.2% | 6950 | 2.90 | 1.12 |

### Example 19

### Cloud Point and Salt Precipitation Temperatures

The cloud points and salt precipitation temperatures for the polymers of Examples 8-17 were measured as described in Example 4.

Cloud points ranged from 55° C. for the polymer from Example 14 to 75.5° C. for the polymer from Example 9 (Table 7). Polymers with 17.5 molar percent or more NaAMPS and about the same amount of VP yielded cloud points as high as 72° C. and salt precipitation temperatures as high as 96.5° C.

TABLE 7
Residual monomer concentrations for the poly(VCL-
NaAMPS-VP) terpolymers of Examples 8-17.

| | | | | cloud | |
|---|---|---|---|---|---|
| polymer from | polymer molar composition | | | point | salt precipitation |
| Example | VCL | NaAMPS | VP | (° C.) | temperature (° C.) |
| 8 | 64.7% | 17.7% | 17.6% | 69.0 | 92.5 |
| 9 | 64.7% | 17.7% | 17.6% | 75.5 | 88.5 |
| 10 | 64.7% | 17.7% | 17.6% | 71.0 | 95.0 |
| 11 | 64.7% | 17.7% | 17.6% | 67.5 | 91.0 |
| 12 | 64.7% | 17.7% | 17.6% | 71.0 | 96.5 |
| 13 | 64.7% | 17.7% | 17.6% | 71.5 | 96.5 |
| 14 | 73.9% | 12.8% | 13.2% | 55.0 | 67.5 |
| 15 | 61.7% | 12.5% | 25.8% | 59.5 | 82.0 |
| 16 | 61.7% | 12.5% | 25.8% | 60.0 | 80.5 |
| 17 | 66.1% | 20.1% | 13.8% | 72.0 | 96.5 |

### Example 20

### Cloud Point and Salt Precipitation Temperatures as a Function of Brine Concentration

The polymers of Examples 8-13, poly(64.7% VCL-17.7% NaAMPS-17.6% VP) (mole ratio), were investigated to determine the cloud points in deionized water and brines and salt precipitation temperatures as a function of brine (NaCl) salt concentration. The method of Example 8 was employed.

The polymer exhibited extraordinarily high cloud points and salt precipitation temperatures (FIGURE). The envelop for clear and cloudy solutions is quite large, and polymer precipitation was not observed for salt concentrations less than 12% (w/w deionized water).

### Comparative Example 1

### Cloud Point and Salt Precipitation Temperature of Poly(VCL)

To illustrate the performance in cloud point and salt precipitation temperature reported in Examples 19 and 20, these two properties also were measured for the homopolymer of VCL (provided in 2-butoxyethanol). This composition is offered for commercial sale as a gas hydrate inhibitor by Ashland Specialty Ingredients under the trade name Inhibex® 101. Measured by the identical test method of Example 4, the cloud point was found to be 38° C. and the salt precipitation temperature was 21° C.

### Method 1: Measurement of Kinetic Gas Hydrate Inhibition

The following steps were executed to measure the kinetic gas hydrate inhibition of polymerization products of this invention:
1. A 500 mL, 316 stainless steel autoclave vessel, equipped with a thermostated cooling jacket, sapphire window, inlet and outlet ports, platinum resistance thermometer (PRT), and a magnetic stirring pellet was selected. The autoclave was rated for use between −25° C. to 400° C. Temperature and pressure data were recorded by a thermocouple and pressure transducer, respectively, and recorded by computer data acquisition software. The cell contents were visually monitored by a horoscope video camera connected to a time lapsed video recorder.
2. The rig was cleaned using prior to running blank or test solutions:
   a. An air drill with a wet emery-paper buffer head was used to passivate the interior stainless steel surface wall of the rig.
   b. The vessel was then rinsed several times with double distilled water and dried with lint-free tissue.
3. Approximately 200 g of gas hydrate inhibitor solution, made in double-distilled water, were added to the rig to produce a defined concentration (e.g., 0.5%, 0.6%, 0.75%). The rig top was replaced and tightened.
4. The solution was stirred by a magnetic stirrer at 500 rpm.
5. Then, the autoclave was purged with an experimental hydrocarbon test mixture (Green Canyon Gas) (Table 8) for 60 seconds.
6. The system was pressurized to a defined pressure (e.g., 35 bar, 60 bar) at room temperature.
7. After pressurization, the temperature was reduced from room temperature to attain a predetermined subcooling temperature (T_{sc}) (e.g., 4° C., 7° C.) (see step 11). The reactor pressure was maintained with Green Canyon Gas as the solution temperature was reduced.
8. The pressure and temperature data logging devices were activated.
9. The rig was maintained at the defined chill temperature and pressure until gas hydrates were detected.
10. Hydrate formation in the rig was determined by any one of three indicators: (1) visual detection of hydrate crystals (i.e., non-clear solution), (2) a decrease in vessel pressure due to gas uptake by the solution, or (3) an increase in solution temperature created by the exothermic gas hydrate reaction.
11. A commercial software package, pvtsim (Calsep A/S, Lyngby, Denmark) was used to predict the Green Canyon Gas equilibrium melting temperature. For test pressure of 60 bar, the equilibrium melting temperature is about 17.3° C., respectively. The kinetic gas hydrate inhibition tests were conducted at 60 bar and 7° C. in order to create a subcooling temperature of 10.3° C., respectively.
12. A pass grade was assigned to polymers that did not form gas hydrates within 2,880 minutes at the set T_{sc} and pressure.

TABLE 8
Composition of the experimental hydrocarbon
gas mixture composition.

| | amount |
|---|---|
| component | (molar percent) |
| nitrogen | 0.39 |
| methane | 87.26 |
| ethane | 7.57 |
| propane | 3.10 |
| iso-butane | 0.49 |
| N-butane | 0.79 |
| iso-pentane | 0.20 |
| N-pentane | 0.20 |
| total | 100.00 |

Gas hydrate inhibition efficiency is proportional to the induction time, which is the time from the start of the run (viz., step 8) to the time when gas hydrates are detected (viz., step 10).

### Example 21

### Gas Hydrate Inhibition at 0.5% (w/w) Polymer Addition Level

The induction time for gas hydrate inhibition was measured using Method 1 for the poly(VCL-NaAMPS-VP) polymers of Examples 8 and 10-14. The polymer was added at 0.5% (w/w) addition level to deionized water.

All polymers passed the gas hydrate inhibition test, as gas hydrates were not detected within 2,880 minutes at a subcooling temperature of 10.3° C.

### Example 22

### Gas Hydrate Inhibition at 0.3% (w/w) Polymer Addition Level

A second gas hydrate inhibitor test was conducted for the poly(VCL-NaAMPS-AM) polymer of Example 4 and the poly(VCL-NaAMPS-VP) polymer of Example 8. As before, Method 1 was employed, but this time the polymer were added at 0.3% (w/w) addition level to deionized water.

Both polymers passed the gas hydrate inhibition test, as gas hydrates were not detected within 2,880 minutes at a subcooling temperature of 10.3° C.

### Example 23

### High Temperature Injection

Six solutions were prepared of the polymers from Examples 8-13 at 1% (w/w water) addition level. Then, each polymer solution was quickly injected into a beaker of 15% (w/w water) NaCl solution maintained at 85° C. and then stirred for 1 hour. The final polymer concentration in the blend was 1% (w/w). During this period the mixture turned cloudy, but no polymer precipitated, as evidenced by lack of globule formation and lack or polymer coating on the beaker and stir bar. Afterward, each of the six mixtures was cooled to 10° C., and resumed a clear appearance without any polymer precipitation.

What we claim is:

1. A non-homopolymer polymerized from at least: (A) 50 mole percent or more of a monomer selected from the group consisting of: N-vinyl-2-caprolactam, one of its analogues, and combinations thereof, (B) an alkenyl sulfonic acid monomer, salt thereof, or combinations thereof, and (C) an N-vinyl amide, a (meth)acrylamide or one of its analogues, or combinations thereof.

2. The non-homopolymer of claim 1 wherein said alkenyl sulfonic acid monomer or salt thereof has the general formula: 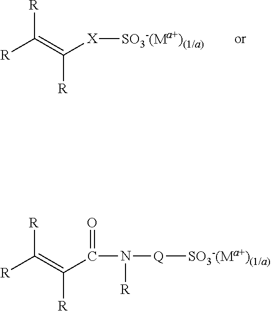
wherein:
M is selected from the group consisting of H, Na⁺, K⁺, Li⁺, Ca⁺⁺, Ba⁺⁺, Mg⁺⁺, Al⁺⁺⁺, NH₄⁺, and combinations thereof; and a is equal to the valence of M;
Q is selected from the group consisting of: a functionalized and unfunctionalized alkylene, arylene, cycloalkylene groups, and combinations thereof., wherein any of the beforementioned groups may be with or without one or more heteroatoms;
each R is independently selected from the group consisting of hydrogen, functionalized and unfunctionalized alkyl, cycloalkyl, aryl groups, and combinations thereof, wherein any of the aforementioned groups may be present with or without one or more heteroatoms; and
X is a direct bond, or is selected from the group consisting of: functionalized and unfunctionalized alkylene, cycloalkylene, arylene groups, and combinations thereof, wherein any of the aforementioned groups may be present with or without one or more heteroatoms.

3. The non-homopolymer of claim 2 wherein said alkenyl sulfonic acid monomer or salt thereof has the general formula: 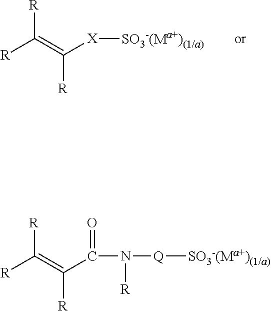
wherein:
M is selected from the group consisting of H, Na⁺, and combinations thereof; and a is equal to the valence of M;
Q is a C₁ to C₁₀ linear or branched alkylene group;
each R is independently selected from the group consisting of hydrogen and functionalized and unfunctionalized alkyl groups, wherein any of the beforementioned groups may be present with or without one or more heteroatoms; and
X is a direct bond, or is selected from the group consisting of: functionalized and unfunctionalized arylene groups.

4. The non-homopolymer of claim 3 wherein said alkenyl sulfonic acid monomer is selected from the group consisting of: 2-acrylamido-2-methylpropane sulfonic acid (AMPS), 2-acrylamido-2-ethylpropane sulfonic acid, 2-acrylamido-2-propylpropane sulfonic acid, 2-methacrylamido-2-methylpropane sulfonic acid, 2-methacrylamido-2-ethylpropane sulfonic acid, 2-methacrylamido-2-propylpropane sulfonic acid, N-methyl-2-acrylamido-2-methylpropane sulfonic acid, N-methyl-2-acrylamido-2-ethylpropane sulfonic acid, N-methyl-2-acrylamido-2-propylpropane sulfonic acid, N-methyl-2-methacrylamido-2-methylpropane sulfonic acid, N-methyl-2-methacrylamido-2-ethylpropane sulfonic acid, N-methyl-2-methacrylamido-2-propylpropane sulfonic acid, 2-acrylamido-1-butane sulfonic acid, 2-acrylamido-1-pentane sulfonic acid, 2-acrylamido-1-hexane sulfonic acid, 2-methacrylamido-1-butane sulfonic acid, 2-methacrylamido-1-pentane sulfonic acid, 2-methacrylamido-1-hexane sulfonic acid, 2-acrylamido-1-heptane sulfonic acid, 2-methacrylamido-1-heptane sulfonic acid, N-methyl-2-acrylamido-1-butane sulfonic acid, N-methyl-2-methacrylamido-1-butane sulfonic acid, N-methyl-2-acrylamido-1-pentane sulfonic acid, N-methyl-2-methacrylamido-1-pentane sulfonic acid, N-methyl-2-acrylamido-1-hexane sulfonic acid, N-methyl-2-methacrylamido-1-hexane sulfonic acid, N-methyl-2-acrylamido-1-heptane sulfonic acid, N-methyl-2-methacrylamido-1-heptane sulfonic acid, salts thereof of each preceding alkenyl sulfonic acids, and combinations thereof.

5. The non-homopolymer of claim 1 wherein said N-vinyl amide is selected from the group consisting of: N-vinyl-2-pyrrolidone and its analogues, N-vinyl-2-piperidone and its analogues, N-vinyl formamide and its analogues, N-vinyl acetamide and its analogues, N-vinyl propionamide and its analogues, N-vinyl butanamide and its analogues, and combinations thereof.

6. The non-homopolymer of claim 1 wherein said (meth)acrylamide or its analogues has the general formula: 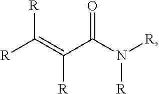
wherein:
each R is independently selected from the group consisting of hydrogen, and functionalized and unfunctionalized alkyl, cycloalkyl, and aryl groups, wherein any of the aforementioned groups may be present with or without heteroatoms.

7. The non-homopolymer of claim 6 wherein said (meth)acrylamide or its analogues is selected from the group consisting of: (meth)acrylamide, N-methyl (meth)acrylamide, N-ethyl (meth)acrylamide, N-(n-propyl)(meth)acrylamide, N-isopropyl (meth)acrylamide, N,N-dimethyl (meth)acrylamide, N,N-diethyl (meth)acrylamide, N,N-di(n-propyl)(meth)acrylamide, N,N-diisopropyl (meth)acrylamide, N-methyl-N-ethyl (meth)acrylamide, N-methyl-N-(n-propyl)(meth)acrylamide, N-methyl-N-(isopropyl)(meth)acrylamide, N-ethyl-N-(n-propyl)(meth)acrylamide, N-ethyl-N-(isopropyl)(meth)acrylamide, N-acryloylpyrrolidine, N-acryloylpiperidine, N-acryloylhexamethyleneimine, N-acryloylheptamethyleneimine, N-acryloyloctamethyleneimine, N-methacryloylpyrrolidine, N-methacryloylaziridine, N-methacryloylpiperidine, N-methacryloylhexamethyleneimine, N-methacryloylheptamethyleneimine, N-methacryloyloctamethyleneimine, and combinations thereof.

8. The non-homopolymer of claim 1 wherein said N-vinyl amide is N-vinyl-2-pyrrolidone and said (meth)acrylamide or its analogues is selected from the group consisting of acrylamide, methacrylamide, and combinations thereof.

9. The non-homopolymer of claim 1 polymerized from at least: (A) 50 mole percent or more of N-vinyl-2-caprolactam, (B) 2-acrylamido-2-methylpropane sulfonic acid, salt thereof, or combinations thereof, and (C) N-vinyl-2-pyrrolidone, acrylamide, methacrylamide, or combinations thereof.

10. The non-homopolymer of claim 1 that:
(i) prevents the formation of gas hydrates, or reduces the growth of gas hydrates, or reduces the tendency of gas hydrates to agglomerate in a fluid comprising water and at least one hydrate-forming molecule,
(ii) has a cloud point of 50° C. or more at 1% (w/w) concentration in deionized water, and
(iii) has cloud point of 30° C. or more at 1% (w/w) concentration in 15% (w/w) NaCl, or a salt precipitation temperature of 30° C. or more at 1% (w/w) concentration in 15% (w/w) NaCl, or an injection temperature of 50° C. or more at 1% (w/w) concentration in 15% (w/w) NaCl.

11. A composition comprising a non-homopolymer polymerized from at least: (A) 50 mole percent or more of a monomer selected from the group consisting of: N-vinyl-2-caprolactam, one of its analogues, and combinations thereof, (B) an alkenyl sulfonic acid monomer, salt thereof, or combinations thereof, and (C) an N-vinyl amide, a (meth)acrylamide or one of its analogues, or combinations thereof.

12. A method for preventing the formation of gas hydrates, or for reducing the growth of gas hydrates, or for reducing the tendency of gas hydrates to agglomerate in a fluid comprising water and at least one hydrate-forming guest molecule, said method comprising contacting said fluid with a composition comprising a non-homopolymer polymerized from at least: (A) 50 mole percent or more of a monomer selected from the group consisting of: N-vinyl-2-caprolactam, one of its analogues, and combinations thereof, (B) an alkenyl sulfonic acid monomer, salt thereof, or combinations thereof, and (C) an N-vinyl amide, or (meth)acrylamide or one of its analogues, or combinations thereof.

13. The method of claim 12 wherein said non-homopolymer is polymerized from at least: (A) 60 mole percent to 75 mole percent N-vinyl-2-caprolactam, (B) 12.5 mole percent to 20 mole percent 2-acrylamido methylpropane sulfonic acid, salt thereof, or combinations thereof, and (C) 12.5 mole percent to 20 mole percent N-vinyl-2-pyrrolidone, (meth)acrylamide, or combinations thereof.

14. The method of claim 12 wherein said hydrate-forming guest molecule is selected from the group consisting of: methane, ethane, ethylene, acetylene, propane, propylene, methylacetylene, n-butane, isobutane, 1-butene, trans-2-butene, cis-2-butene, isobutene, butene mixtures, isopentane, pentenes, natural gas, carbon dioxide, hydrogen sulfide, nitrogen, oxygen, argon, krypton, xenon, and combinations thereof.

15. The method of claim 12 wherein said non-homopolymer is present from about 0.01% to about 5% by weight of said water present in said fluid.
